(19) United States
(12) Patent Application Publication
(10) Pub. No.: US 2006/0002543 A1
(43) Pub. Date: Jan. 5, 2006

(54) Computer telephony integration

(76) Inventor: Paul Benjamin Newland, Monmouth County, NJ (US)

Correspondence Address: Thomas J. Onka, Esq.;Synnestvedt Lechner & Woodbridge, LLP, P.O. Box 592, Princeton, NJ, 08542, US

(21) Appl. No.: 10/882,064

(22) Filed: Jun. 30, 2004

(51) Int. Cl. H04M 1/00; H04M 3/00

(52) U.S. Cl. 379/368

(57) ABSTRACT

An enhanced computer keyboard connected to the user's computer to thereby provide an improved user interface for controlling a telephone when the user is primarily operating a computer. In particular, this improved user interface involves locating the button controls of the telephone on the computer keyboard, thereby keeping the mental focus of the user where it typically resides during the user's work day—on the computer display and on the computer keyboard. Additional embodiments of the invention make use of the assets of the computer (e.g., the computer display) to augment various telephone features.

### FIELD OF THE INVENTION

The present invention relates to incorporating telephony device functions into a computer.

### BACKGROUND OF THE INVENTION

The typical work environment for many office personnel is work area which comprises a telephone and a computer/ computer terminal (referenced generically hereafter as a “PC”). Frequently, such personnel are continually going from one of these devices to the other. Picking up or replacing the handset from a telephone cradle is a peripheral vision and peripheral mental event. Very little mental focus is needed to deal with a handset, even if located 90 degrees off center from the user's visual/mental focus. Dialing on the other hand, or otherwise controlling the telephone, requires much more mental focus.

In addition to these considerations, telephone systems are becoming increasingly popular that allow users to place “telephone” calls over computer networks, such as the Internet. The Internet Protocol (IP) phone instruments associated with such communication come in a variety of forms. One form is a peripheral device that plugs into an input/output port on the user's computer. This device usually resembles a conventional slimline desk phone. Another form is a fully integrated unit with a base, a handset, and usually a small two-six inch diagonal display screen of some sort. An example of this device is marketed by Avaya Inc. of Basking Ridge, N.J., as model 4620 IP Telephone.

While such IP phones may have a support application running on the user's PC, these IP phones are not easily integrated into the PC. In particular, two common devices (the PC and the telephone), each having key-button controls, are physically presented to the user and require significant shifting of mental focus as the user goes from one device to the other.

The present invention is directed to the problem of developing a means to control the telephone from a PC such that a portion of the telephone is ergonomically incorporated in to the PC.

### SUMMARY OF THE INVENTION

The present invention modifies the computer keyboard of the user's PC to thereby provide an improved user interface for controlling a telephone when the user is primarily operating a computer. In particular, the present invention comprises locating the button controls, and optional lamp status indicators, of the telephone onto the PC keyboard, thereby keeping the mental focus of the user where it typically resides during the user's work day—on the PC display and on the PC keyboard. Additional embodiments of the invention make use of the assets of the PC (e.g., the PC display) to augment various telephone features.

### BRIEF DESCRIPTION OF THE DRAWINGS

Various embodiments of the present invention will now be described in detail in conjunction with the annexed drawings, in which:

FIG. 1 is a mostly schematic representation of a system according to an embodiment of the present invention;

FIG. 2 illustrates a keyboard for a computer according to the embodiment of the invention illustrated by FIG. 1;

FIG. 3 depicts an example of an IP telephone and various features present thereon; and,

FIG. 4 illustrates an additional embodiment of the invention employing a local telephone switch.

### DETAILED DESCRIPTION

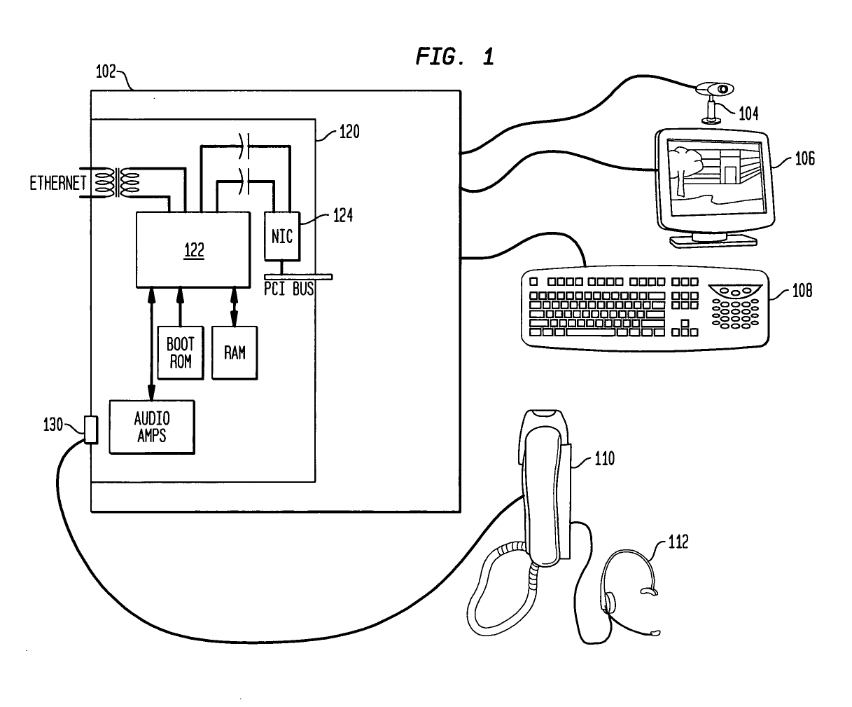

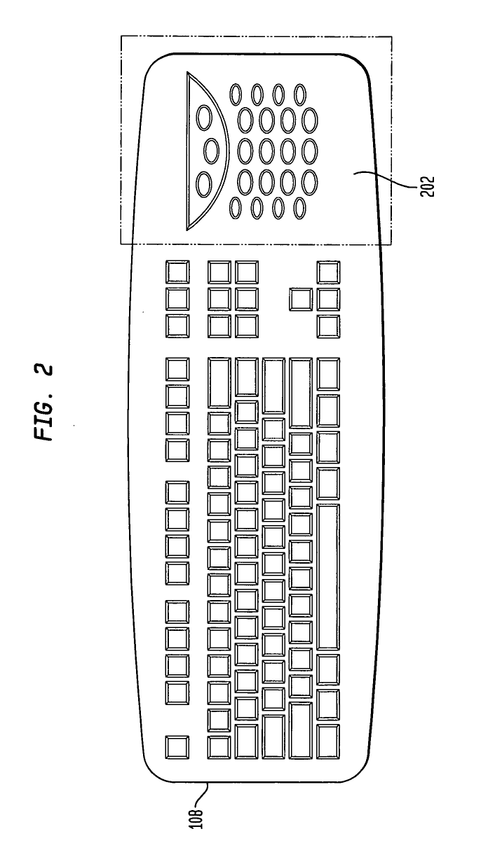

The present invention includes a PC and an associated telephone. FIG. 1 illustrates an embodiment of the invention in which a camera 104, monitor 106 and keyboard 108 are attached to a PC 102. Of significance and as further illustrated in FIG. 2, the keyboard 108 comprises a section 202 having keys similar to those of a conventional phone's dial pad, used for dialing a call. Moreover, section 202 also contains additional buttons that are used for invoking various communication functions commonly found on modern telephones.

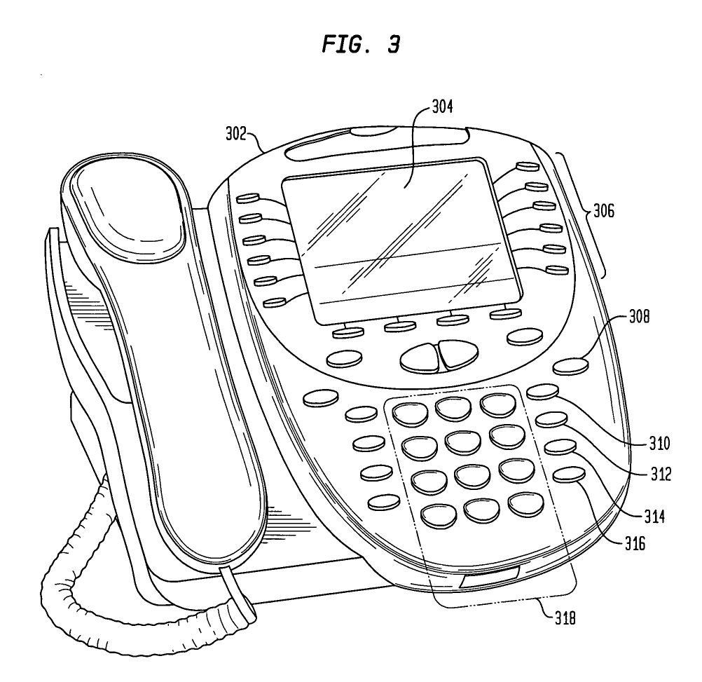

FIG. 3 illustrates an example of such a modern telephone, an IP telephone marketed by Avaya Inc. as Model 4620 IP Telephone. As depicted in FIG. 3 this phone 302 not only contains a conventional phone dial pad 318, but buttons associated with features found on most modern office phones such as, a hold button 308, a transfer button 310, a conference call button 312, a drop button 314 and a redial button 316. In addition, the phone contains a display screen 304 which illustrates various additional functions that can be invoked by pressing buttons 306 associated with the depicted functions.

As further depicted in FIG. 1, various electronic components that are commonly found in a modern IP telephone are located on a phone Ethernet card 120. In particular, these components include a voice over IP Ethernet CPE Engine 122 and a PC Network Interface Card (NIC) 124. The handset/cradle combination 110 is connected to the card 120 via a special handset port 130. As illustrated, the handset/cradle combination 110 supports a headset 112.

With the hardware arrangement depicted in FIG. 1, it is not necessary to locate a display or even various feature buttons on the telephone handset/cradle combination 110. In particular, information formerly presented to the user on a phone LCD display (e.g., 304) can be displayed in a window on the PC monitor 106. Features formerly invoked by phone buttons could be implemented as special keys on the computer keyboard which are part of this invention and/or invoked by pull-down menu screens or button images on the PC monitor—from which a user can make a selection.

Keyboard 108, illustrated in FIGS. 1 & 2, depicts the telephone keypad being located in the area of a PC keyboard where the accountant's keypad would normally be placed. The invention is not so limited as other configurations are contemplated in which the telephone keypad is placed in a different area of the PC keyboard. Further, the PC keyboard itself can be modified in a variety of ways as to shape and dimensions to accommodate the telephone keypad.

In further embodiments of the invention the keyboard 108 would also include a jack to support a telephone headset in addition to a handset or in lieu of handset 110. The keyboard could also include a handset used with or without an associated cradle. In the latter case the handset could contain a contact switch (hook switch) in the earpiece, as is well-known in the prior art (and commonly found in hospital rooms). The associated handset may also be used without a cradle or integral hook switch by providing a toggle on/off button on the phone pad 202 area of the keypad 108 that controls the onhook/offhook state of the telephone function, similar in function to that of the speakerphone button, but using the handset, rather than the speakerphone, as the audio I/O device.

In various embodiments of the invention, the telephone functions that are associated with the telephone keypad 202 may be partitioned between the telephone proper and the PC. In one embodiment, only the keyboard and optionally the associated keyboard lamps may reside within the PC system and all other telephony functions are implemented within the telephone. In an additional embodiment at least some of these functions that have been traditionally performed within the telephone are performed via software within the PC that is associated with the PC keyboard. In another embodiment at least some of these functions are implemented by specialized hardware that is physically within and electronically part of the PC that is associated with the PC keyboard. In yet another embodiment these functions are implanted by a separate computational device that is not associated with the PC keyboard and may be physically distant from the PC keyboard (and in the extreme, geographically distant from it).

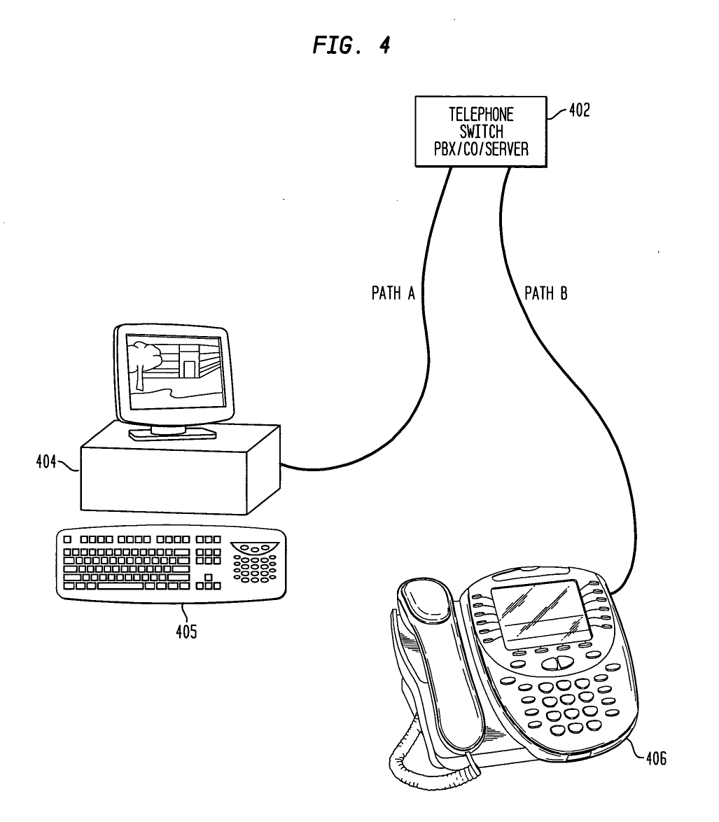

FIG. 4 depicts an example of this latter embodiment in which a centralized telephone “switch” 402 is such a separate computational device. As illustrated, a telephone 406 is connected via Path B to the centralized telephone switch 402, which might be implemented as a PBX, central office or computer server, either on premise with the telephone or at considerable distance from the telephone, perhaps on a different continent. Additionally, the PC 404 will also have some connectivity to that same switch 402, most likely through a high speed network (Path B), but other communications links between PC and switch could be used. A software control program would be active on the PC to communicate the button presses on the telephone keys that reside on the PC keyboard 405 to the switch 402. Similarly, a software control program on the telephone 406 would be active within the telephone to communicate button presses on the telephone keys that reside on the telephone to switch 402. In additional embodiments of the invention, at least some of the keys on the telephone pad would each have a corresponding key on the PC keyboard. As a result, the user could simply press one of these keys on either the telephone keypad on the PC keyboard 405 or the telephone keypad on the telephone 406, with the same functionality being invoked. Additionally, corresponding keypad lamps (LEDs) would exist so that a state change that would normally be indicated on the telephone keypad lamps would be communicated as well to the PC so that the PC control program would illuminate or extinguish the keypad lamps on the PC keyboard, to remain in step with the lamps on the telephone.

In these various embodiments communications between the telephone keypad on the PC keyboard and the machine that is providing the telephone functionality (e.g., physically separate telephone, software running on the PC's primary processor, or an adjunct telephone processor within the PC system) may be implemented in a variety of ways. If the enhanced PC keyboard and telephone device are in close geographical proximity, then the communication path between the telephone keypad located on the PC keyboard and the telephone may be established by:
Through a telephone switch device as depicted in FIG. 4
Direct wire connection
Indirect wired connection, passing signals through the PC as depicted in FIG. 1
Wireless connection via:
   Radio
   infra-red
   induction
   acoustical (e.g., sub-sonic, sonic, and super-sonic)

If the enhanced PC keyboard and telephone device are not in close geographical proximity, then the communication path between these items may comprise a connection over a private or public packetized data network (e.g., the Internet), circuit switched network or other long range communications facility.

While the invention has been described with reference to the preferred embodiment thereof, it will be appreciated by those of ordinary skill in the art that modifications can be made to the structure and elements of the invention without departing from the spirit and scope of the invention as a whole.

What is claimed is:

1. A computer telephony integration adapter, comprising:
a display;
an augmented computer keyboard comprising a plurality of telephone control buttons; and,
a phone card contained in the computer, said card comprising a voice over IP engine and a Network Interface Card (NIC).

2. The computer telephony integration adapter of claim 1 wherein said phone card is an Ethernet card and said engine is an Ethernet CPE engine.

3. The computer telephony integration adapter of claim 1 wherein said telephone control buttons are selected from the group consisting of a hold button, a transfer button, a conference call button, a drop button, a mute button, a speaker button, a telephone dialing pad, at least one button used for interacting with a phone display device, and combinations thereof.

4. The computer telephony integration adapter of claim 3 wherein at least part of the computer display functions as the phone display device.

5. The computer telephony integration adapter of claim 1 wherein said augmented computer keyboard further comprises a jack to support a telephone headset.

6. The computer telephony integration adapter of claim 1 wherein said augmented computer keyboard further comprises a jack to support a telephone handset.

7. The computer telephony integration adapter of claim 1 wherein at least some of said telephone control buttons correspond to telephone functions and said functions are implemented utilizing software contained in said computer.

8. The computer telephony integration adapter of claim 1 at least some of said telephone control buttons correspond to telephone functions and said functions are implemented utilizing software contained in a processor other than said computer.

9. A telephony control mechanism, comprising
A telephone comprising acoustical transducers capable of conveying human speech and a plurality of keybuttons for controlling the telephone;
a PC having a keyboard, said keyboard comprising representative controls corresponding to at least some of said keybuttons; and,
a means of communication between said keyboard and said telephone, in which the representative controls on said keyboard control said telephone.

10. The telephony control mechanism of claim 9 further comprising status lamps associated with at least some of the keybuttons on said telephone and with at least some of said representative controls on the keyboard.

11. A method of integrating functions performed by a telephone and a computer, said method comprising:
providing an augmented computer keyboard comprising a plurality of telephone control buttons;
establishing a communication link between the computer keyboard and the telephone; and,
enabling a user at the computer to invoke one or more telephone functions.

12. The method of claim 11 wherein said communication link comprises a direct wire connection.

13. The method of claim 11 wherein said communication link comprises a telephone switch.

14. The method of claim 11 wherein said communication link comprises passing signals through the computer.

15. The method of claim 11 wherein said communication link comprises wireless communication.

16. The method of claim 11 wherein the computer comprises a display, said method further comprising:
permitting the computer user to select a phone function to be performed from a list exhibited on the display.

17. The method of claim 11 wherein said enabling step comprises utilizing software contained in the computer.

18. The method of claim 11 wherein said enabling step comprises utilizing software contained in a processor other than the computer.

19. The method of claim 11 further comprising:
providing the user with status lamps associated with at least some of the keybuttons on said telephone; and,
indicating status of various phone functions to the user by using said status lamps.
